(19) United States
(12) Patent Application Publication
(10) Pub. No.: US 2004/0064302 A1
(43) Pub. Date: Apr. 1, 2004

(54) Emulation method for managing a reader for a chip card incompatible with an environment

(76) Inventor: Herve Cunin, Aix En Provence (FR)

Correspondence Address: Roland PLOTTEL, ROCKFELLER CENTER SM, PO BOX 293, NY, NY, 10185-0293, US

(21) Appl. No.: 09/772,298

(22) Filed: Jan. 29, 2001

(30) Foreign Application Priority Data
Oct. 10, 2000 (FR) 00/13340

(51) Int. Cl. G06F 9/455

(52) U.S. Cl. 703/27

(57) ABSTRACT

A personal computer emulates the functionality of a smart card reader that conforms with the PCSC standard, to enable the computer to communicate with a reader that complies with the EMV standard for financial transactions. An interface in the personal computer checks commands being sent to the reader, to determine if they represent a case in which data is to be received in a response from the reader. If so, the interface emulates the return of a state word which identifies the amount of data in the response. In reply, the interface receives a new command, to which it then responds with data received from the reader.

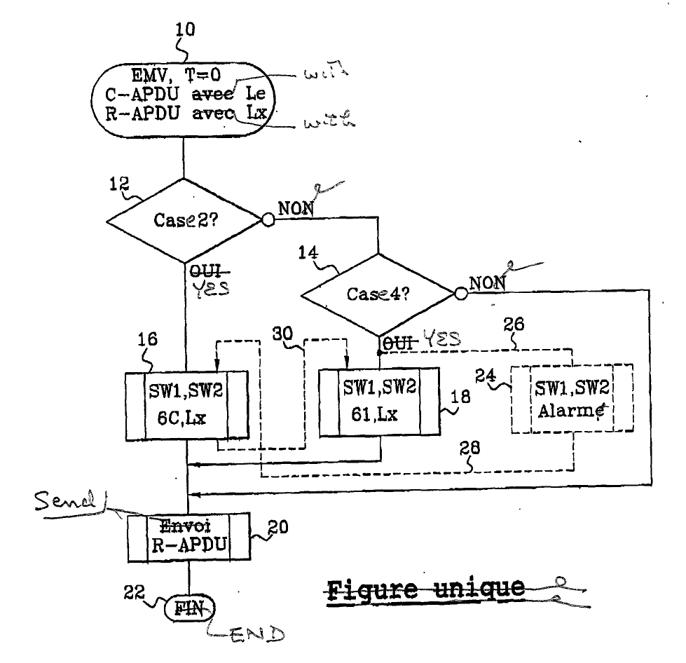

The invention concerns chip card readers functioning according to the “EMV” standard and able to be used in a PCSC-standard environment and, more particularly, a method of emulating the PCSC environment in order to manage the EMV-standard reader.

The acronym “EMV” refers to a standard known by the English expression “Europay Mastercard and Visa” and the acronym “PCSC” refers to a standard known by the English expression “Personal Computer Smart Card”.

Microcircuit cards or chip cards are for example used for making transactions, notably monetary transactions, and function in accordance with strict rules with a view to guaranteeing the security of the transactions. These rules are complied with when the chip card and reader function according to the “EMV” standard.

However, the chip card reader to the EMV standard can be caused to be used in association with a personal computer connected, for example, to a network of the Internet type in order to perform electronic transactions. This association presents incompatibilities with regard to the communication of the chip card.

There is therefore a need to mitigate these incompatibilities so as to be able to Use a chip card reader to the EMV standard in association with a personal computer which can communicate with a chip card according to the PCSC standard.

To this end, the invention provides that the personal computer emulates the functionalities of a PCSC standard reader with regard to communication with the chip card reader, which allows communication between the reader and personal computer.

The invention therefore concerns a method of emulating a chip card reader functioning according to the PCSC standard in order to manage a chip card reader functioning according to the EMV standard and communicating with the chip card according to the protocol T=0, characterised in that it comprises the following operations consisting of:

(a) determining the type of APDU exchanges for which it is necessary to effect an emulation,

(b) emulating the return of a state word (SW1, SW2) in compliance with the standards to the PCSC environment,

(c) when the type of APDU exchange corresponds to a Case 2 as defined in ISO 7816-4, receiving the command C-APDU complying with the state word,

(d) when the type of APDU exchange corresponds to a Case 4 as defined in the standards, receiving the command GET-RESPONSE using the state word,

(e) returning A-APDU in response to C-APDU or to GET-RESPONSE.

According to the invention, operations (c) and (d) can be performed in the reverse order.

Operation (c) can be followed by the following operation consisting of:

(c₁) emulating the return of a state word (SW1, SW2) complying with the standards to the PCSC environment as provided for when the type of APDU exchange corresponds to a Case 4.

Operation (b) can be replaced by operations (b′ and b″) and operation (d) replaced by an operation (d″) consisting of:

(b′) emulating an alarm state, which can relate to the application of the chip card, sending to the PCSC environment the state word (SW1, SW2) complying with the standards,

(d′) receiving the command GET-RESPONSE parameterised such that the number of bytes awaited is 0,

(b″) emulating a state word (SW1, SW2), complying with the standards, to the PCSC environment as provided for when the type of APDU exchange corresponds to Case 4.

Other characteristics and advantages of the present invention will emerge from the reading of the following description of a particular example embodiment, the said description being given in relation to the accompanying drawing, in which:

the single FIGURE is a flow diagram illustrating the method according to the invention.

The personal computer with which the chip card reader to the EMV standard must communicate comprises a communication interface, referred to as “IFD Handler”, “IFD” being the acronym for the English expression “Interface Divide”.

According to the invention, this interface is used for emulating the functionalities of a reader to the PCSC standard. This interface receives from the application a command C-APDU which transmits it to the reader, which in return sends a response R-APDU. APDU is the acronym of the English expression “Application Protocol Data Unit”. Knowing C-APDU, R-APDU and the fact that the protocol is of the type T=0, the IFD interface is in a position to determine whether it is appropriate to make an emulation according to the circumstances which it can detect.

This emulation must be effected for the APDU exchange of Case 2 or Case 4 of ISO 7816-4 inspiring the PCSC standard, and this for a communication according to the protocol T=0.

The starting state is defined by state 10 of the flow diagram in the single FIGURE. Step 12 consists of detecting whether it is a question of a Case 2, this case being characterised by the content of C-APDU, that is to say containing a parameter Le indicating the number of bytes of the data of R-APDU and not containing any input date. In this case, the interface must emulate the return of a state word consisting of two bytes of value SW1=6C and SW2=Lx, Lx being the number of bytes of the data of R-APDU. In return, it receives a repetition of C-APDU with Le=Lx.

In response to this new command, it is possible to return the P,=APDU with the same number Lx of bytes. If Case 2 is not detected by step 12, step 14 makes it possible to detect a Case 4 which is characterised by the parameter Le in the presence of input data in C-APDU. In this case, the interface must emulate the return of a state word consisting of two bytes of value SW1=61 and SW2=Lx. In return, it receives a command called “GET-RESPONSE”, which comprises a parameter Le=Lx. In response to this command, the interface sends back the R-APDU previously received from the reader.

If neither of these two types of APDU exchange, Case 2 or Case 4, is detected, it is not necessary to effect an emulation and R-APDU is returned without emulation.

It should be noted that Case 2 can be dealt with by passing through the Came 2 emulation phase with any Lx, and then the Case 4 emulation phase with the appropriate value Lx. After step 16, step 18 is passed through, as indicated in dotted lines 30 in the single FIGURE, before going to step 20.

With regard to Case 4, an alarm state 24 can be emulated by passing through 26, as provided for by ISO 7616 or EMV in which

SW1=62 or 63, and

SW2=xx or xx

or something connected with the application in the card with

SW1=9x and SW2=xx

SW1≠90 and SW2≠00.

In return, it receives the command GET-RESPONSE parameterised so that the number of bytes expected is 0.

The emulation ends with step 16, and then step 20 via the connection 28.

The description which has just been given shows the steps of an emulation method which comprises the following operations consisting of:

(a) determining the types of APDU exchanges for which it is necessary to effect an emulation,

(b) emulating the return of a state word (SW1, SW2) in compliance with the standards to the PCSC environment,

(c) when the type of APDU exchange corresponds to a Case 2 as defined in ISO 7816-4, receiving the command C-APDU complying with the state word,

(d) when the type of APDU exchange corresponds to a Case 4 as defined in the standards, receiving the command GET-RESPONSE using the state word,

(e) returning R-APDU in response to C-APDU or to GET-RESPONSE.

In this method, operations (c) and (d) can be in the reverse order.

Operation (c) can be followed by the following operation consisting of:

(c₁) emulating the return of a state word (SW1, SW2), complying with the standards, to the PCSC environment as provided for when the type of APDU exchange corresponds to a Case 4.

Operation (b) can be replaced by operations (b′ and b″) and operation (d) replaced by the operation (d′) consisting of;

(b′) emulating an alarm state, which can relate to the application of the chip card, sending to the PCSC environment the state word (SW1, SW2) complying with the standards,

(d′) receiving the command GET-RESPONSE parameterised and such that the number of bytes awaited is 0,

(b″) emulating a state word, (SW1, SW2), complying with the standards, to the PCSC environment as provided for when the type of APDU exchange corresponds to Case 4.

1. A method of emulating a chip card reader functioning according to the PCSC standard in order to manage a chip card reader functioning according to the EMV standard and communicating with the chip card according to the protocol T=0, characterized in that it comprises the following operations consisting of:
(a) determining the types of APDU exchanges for which it is necessary to effect an emulation,
(b) emulating the return of a state word (SW1, SW2) in compliance with the standards to the PCSC environment,
(c) when the type of APDU exchange corresponds to a Case 2 as defined in ISO 7816-4, receiving the command C-APDU complying with the state word,
(d) when the type of APDU exchange corresponds to a Case 4 as defined in the standards, receiving the command GET-RESPONSE using the state word,
(e) returning R-APDU in response to C-APDU or to GET-RESPONSE.

2. A method according to claim 1, characterised in that operations (c) and (d) are in the reverse order.

3. A method according to claim 1 or 2, characterised in that operation (c) is followed by the following operation consisting of:
(c₁) emulating the return of a state word (SW1, SW2) complying with the standards to the PCSC environment as provided for when the type of APDU exchange corresponds to a Case 4.

4. A method according to claim 1 or 2, characterised in that operation (b) is replaced by operations (b′) and (b″) and operation (d) replaced by an operation (d′) consisting of:
(b′)emulating an alarm state, which can relate to the application of the chip card, sending to the PCSC environment the state word (SW1, SW2) complying with the standards,
(d′)receiving the command GET-RESPONSE parameterised such that the tuber of bytes awaited is 0,
(b″) emulating a state word, (SW1, SW2) complying with the standards, to the PCSC environment ad provided for when the type of APDU exchange corresponds to Case 4.
